(19) United States
(12) Patent Application Publication
(10) Pub. No.: US 2008/0315684 A1
(43) Pub. Date: Dec. 25, 2008

(54) Square-wave modulated voltage dip restorer

(75) Inventors: Eric Ka Wai Cheng, Hong Kong (HK); Siu Lau Ho, Hong Kong (HK); Kit Po Wong, Hong Kong (HK)

Correspondence Address: ERIC KA WAI CHENG, THE HONG KONG POLYTECHNIC UNIVERSITY, HUNG HOM, KOWLOON, HONG KONG, CN

(73) Assignee: The Hong Kong Polytechnic University, Kowloon (HK)

(21) Appl. No.: 11/819,004

(22) Filed: Jun. 25, 2007

(51) Int. Cl. H02J 3/18; G05F 1/44

(52) U.S. Cl. 307/45

(57) ABSTRACT

The present invention relates a dynamic voltage restorer (DVR) system and methods for addressing voltage dips. The instant DVR incorporates high frequency technology, such as a high frequency transformer, to generate a square wave voltage from a storage device, such square wave being modulated prior to being delivered to a load. The generation of the square wave and modulation thereto creates a voltage that reacts fast to voltage dips, while addressing wide ranging harmonics usually present in square waves.

### BACKGROUND

Voltage dip is one of the main concerns of power quality for industry and for the electrical system management in buildings. It is more important than other forms of power quality issues such as harmonics and power factor. This is mainly because of the extensive use of electronic and digital devices in modern electrical distribution as these devices are very sensitive to voltage dips. In a manufacturing plant, it may cause a complete shutdown of machinery and the associated financial losses could be very high. For buildings, the sudden shutdown of an escalator may result in an accident. The shutdown of the other power supplies or the elevators may cause inconvenience to the public. Voltage dip is also the major cause of power equipment shutdown.

Typical reasons for voltage dip are due to the switching of high current load, cable fault, lightning strike, and faults in either the distribution or the transmission networks. In some cases, due to the magnetic coupling or incorrect wiring, fault current from one network could be coupled to the adjacent network. Fault current flowing in finite impedances could also give rise to voltage dips in the distribution systems.

Typical voltage dip is usually of the order of tens to hundreds of milliseconds, but the damage would be extended over a long period and the associated financial loss may be very high. Typical examples affected in industrial processes are those in printing, glassmaking, garment manufacturing, and electroplating. Many of the modern devices trip when the supply voltage is reduced by more that 15% of the nominal value. High-intensity discharge (HID) lamps are being used commonly in stadium, playground, and as public lighting but they could be extinguished easily due to voltage dip and these lamps are unable to be switched on again within 5 min.

Many transient problems may only result in the loss of less than one cycle of the main's frequency. Typical causes are switching transients of heavy load or capacitor banks, electrostatic discharge, and large inverter staring transient. Dynamic voltage restorer (DVR) is now used to compensate for the voltage dip. Generally it is an electronic circuit that defects the voltage dip and produces necessary voltage to compensate for it. The line voltage in the network is then protected and any voltage dip is restored within a very short time. The associated appliances and voltage-sensitive devices are protected from fault.

The configuration of a DVR is to rectify ac into dc and the energy is stored using capacitors. The dc voltage is inverted into the ac, which is programmed to produce a corresponding amount of compensating voltage to offset the dips. Usually a transformer is used for isolation and voltage stepping. A common problem of the DVR is the response time. The device should respond to the voltage dips within a cycle. However, in order to give a sinusoidal voltage output, the dc/dc conversion of the DVR is realized using pulse-width modulation and a low-pass filter is needed. The dynamic performance of the low-pass filter is, however, a main concern. It usually slows down the dynamic response. Some DVRs use pure square wave instead of the sine wave. For these devices, even though the response is quick, as square waves can be generated instantaneously, the associated harmonics are large.

Another concern is isolation. Because a dc/ac converter is connected in series with the line, isolation is needed and the response time of the transformer then becomes a concern as virtually all power transformers operate at the main frequency, which is usually 50/60 Hz. The transformer size is also large and it inevitably increases the total size of the DVR. Moreover, the reliability of the conventional DVR has not been studied thoroughly in reported literatures.

The size, weight, and cost of DVR therefore warrant improvement. Conventionally, because of the use of isolation transformer, the total size of the DVR is dominated by the transformer. The overall weight and cost are therefore not favorable. However, by using high frequency switching techniques, the size of the transformer can be reduced significantly.

It is an object of the present invention to overcome the disadvantages and problems in the prior art.

### DESCRIPTION

The present invention proposes a DVR that is capable of very fast reaction while avoiding the generation of wide ranging harmonics.

The present invention has usefulness to address voltage dips for electrical systems in industrial environments

The present invention uses a dc/dc converter with a high frequency transformer whose size is at maximum 2% of the size of transformers used in prior art DVR.

These and other features, aspects, and advantages of the system and methods of the present invention will become better understood from the following description, appended claims, and accompanying drawings where:

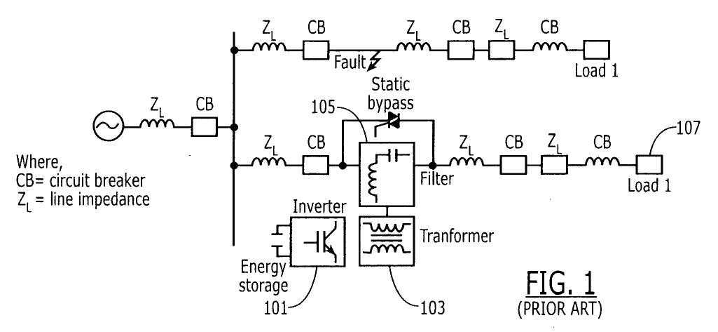

FIG. 1 shows a dynamic voltage restorer (DVR) as used by the prior art.

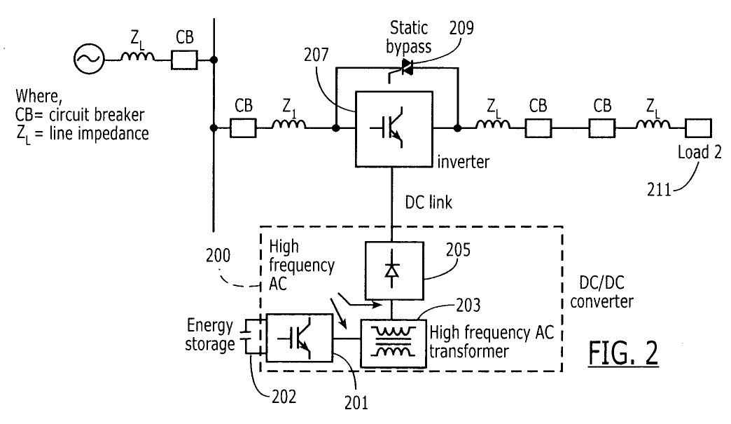

FIG. 2 shows a DVR designed in accordance with the present invention.

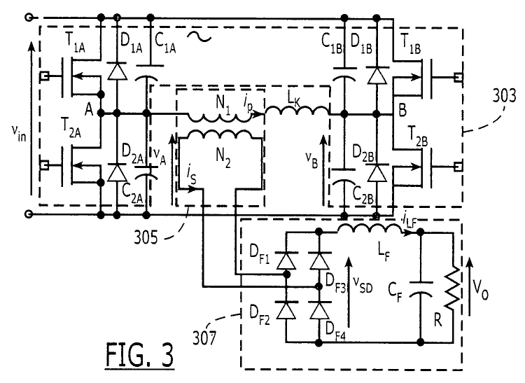

FIG. 3 teaches an embodiment of the circuit of a dc/dc converter as used in the DVR of the present invention.

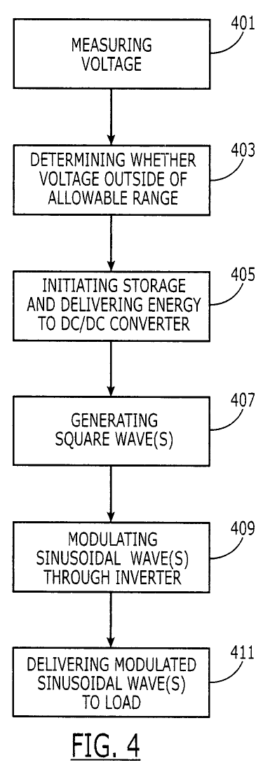

FIG. 4 is a method of compensating for a voltage dip in accordance with the present invention.

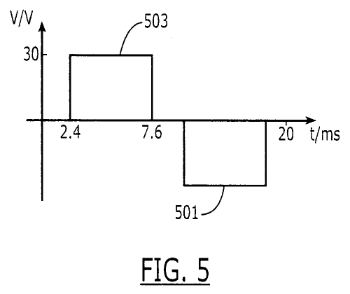

FIG. 5 shows the square waves generated by the dc/dc converter used in the present invention.

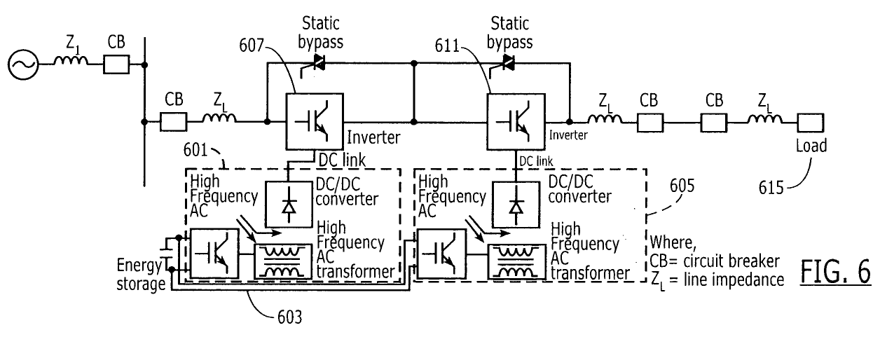

FIG. 6 shows an alternative embodiment of the DVR capable of generating multiple square waves.

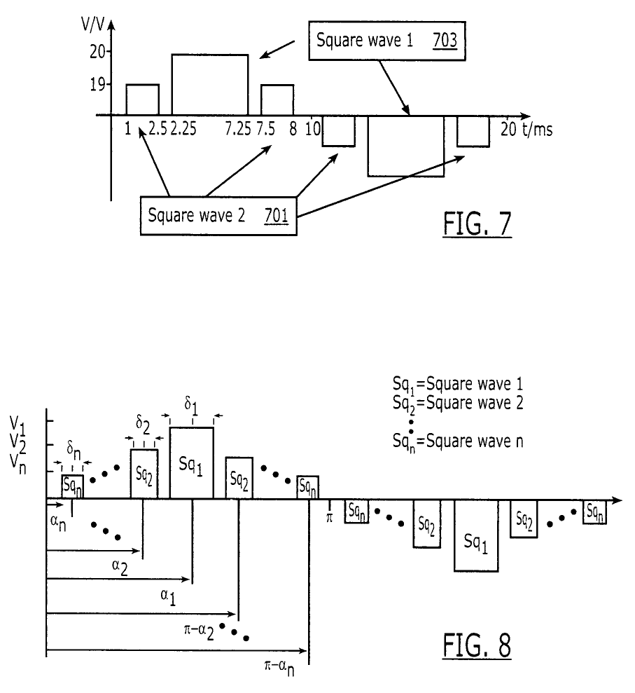

FIG. 7 shows the multiple square waves generated by a DVR possessing multiple DC/DC converters.

FIG. 8 exhibits multiple square generated by a system in accordance with the present invention.

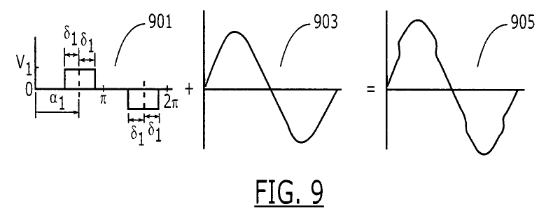

FIG. 9 shows the generation of a modulated square wave in accordance with the present invention.

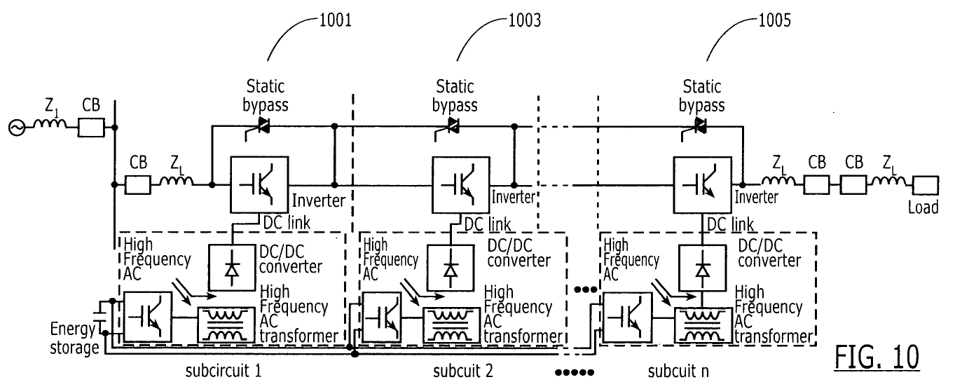

FIG. 10 shows a system, in accordance with the present invention, for generating multiple square waves.

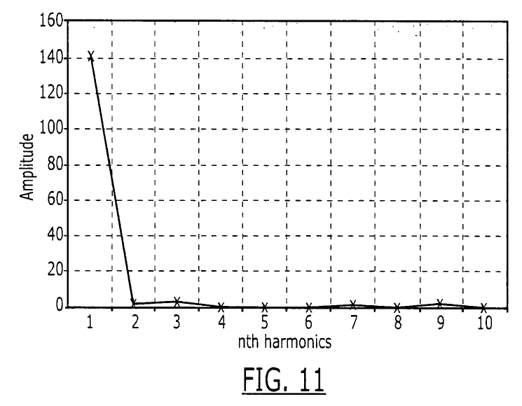

FIG. 11 shows the measured harmonics created from multiple square waves.

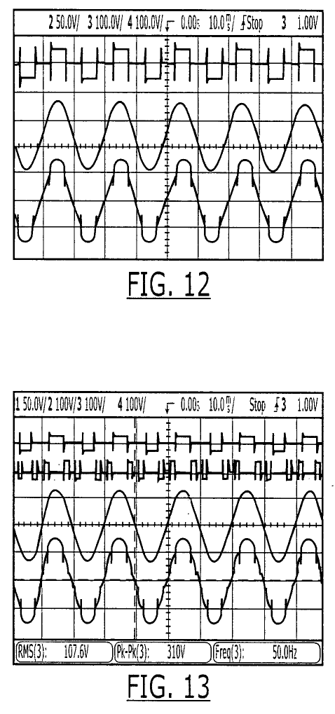

FIG. 12, with reference to example 1, analyzes square waves, sinusoidal waves, and modulated square wave.

FIG. 13, with reference to example 2, analyzes square waves, sinusoidal saves, and modulated square waves of a system possessing multiple dc/dc converters.

The following description of certain exemplary embodiment(s) is merely exemplary in nature and is in no way intended to limit the invention, its application, or uses. Throughout this description, the term “nominal” refers to a value or level set by a particular government or entity. The term “nominal supply voltage” shall refer to the supply voltage level or minimum set by a government entity in a particular locale. The term “voltage dip” shall refer to delivery of a voltage below its nominal value for a length of time not exceeding 30 seconds.

FIG. 1 is an example of a dynamic voltage restorer (DVR) according to the prior art. The conventional method of voltage dip restorer is based on an inverter 101. Its voltage is regulated and added to the main's voltage in order to provide a fixed-voltage output. FIG. 1 shows a typical circuit of the DVR. Z_{L} and CB are the line impedance and circuit breaker, respectively. When there is a fault in the adjacent line, the voltage dips and the DVR detects the dipped voltage. The inverter 101 is then regulated to compensate for the differences in voltage. The output voltage is pulse-width modulated (PWM) regulated and therefore a low-pass filter 105 is needed to change the PWM voltage into a sinusoidal ac. Because of the presence of the filter, the dynamic performance is slow when there is a voltage dip. An energy storage device is used to provide dc for the inverter 101 during the voltage dip period. Usually the energy stored in the storage device is obtained from the mains through an ac/dc converter. A low-loss static switch, such as a triac or two thyristors connected in antiparallel, is used to bypass the mains current when there is no fault to ensure the normal current can pass through the line directly instead of via the DVR. Because of the isolation needed, a transformer 103 is connected between the inverter and the line. This transformer 103 operates at the mains frequency and therefore its size is large.

FIG. 2 is an embodiment of a DVR designed according to the present invention, such DVR containing an isolated dc/dc converter 200, an inverter 207, and a static bypass 209 connected to a load 211. The isolated dc/dc converter 200 has as its purpose to provide a square wave to the load via the inverter. The dc/dc converter 200 contains an inverter 201, a high frequency transformer 203, and diode circuitry 205. The dc/dc converter 200 is electrically connected to an energy storage device, for example a capacitor. The inverter 201 accepts a dc voltage from the storage device 202 and output from the inverter is pulse width modulated. The high frequency transformer 203 is used for passing high frequency current generally from several kilohertz (1-3 kHz) to tens of kilohertz (90-100 kHz). As the transformer 203 only operates at high frequency, the size of the transformer 203 is between 0.1 to 5% of the size of a transformer used in DVR's of the prior art. Standard transformers usually operate at 50/60 Hz. The transformer 203 possesses windings having turns with primary and secondary sides, the number of turns based on the desired ratio to step up and step down the voltage. The transformer 203 is suitable for providing necessary voltage conversion to the system.

The converter 200 also contains diode circuitry 205, for example, rectifier diodes. The diodes 205 are connected in antiparallel format. The diode circuitry 205 can further include switching devices, capacitors, and other electronic components.

The converter 200 is isolated from the DC link and the load 211. The DVR further contains an inverter 207 said inverter connected in line with the load 211. The inverter is preferably an H-bridge inverter. The inverter 207 is used for delivering a voltage from the dc/dc converter 200 to the load 211. Through the inverter 207, the square wave generated from the converter 200 is modulated via sinusoidal signal. The inverter 207 through impedances and circuit breakers provides a compensated square wave delivered to the load 211.

In the event that a voltage dip is not incurred, the voltage is not to be taken through the inverter 207 but rather through the static bypass 209 to the load 211. Upon a voltage dip occurring, the voltage will be analyzed, voltage dip will be detected, and taken through the inverter 207.

FIG. 3 is an embodiment of a circuit diagram of the dc/dc converter containing an inverter 303, a transformer 305, and diode circuitry 307. The dc/dc converter provides square wave voltage to the inverter 303 of the DVR via voltage V₀. The inverter 303 can comprise diodes in anti-parallel format, i.e. D_{1A}, D_{2A}, D_{1B}, and D_{2B} and switching devices, i.e. T_{1A}, T_{1B}, T_{2A}, and T_{2B} and capacitors, i.e. C_{1A}, C_{2A}, C_{1B}, and C_{2B}. The transformer 305 can have windings of N₁ for the primary winding, and N₂ for the secondary winding.

FIG. 4 is a method of generating a modulated square wave in accordance with the present invention, comprising the steps of measuring the voltage from a source 401, determining whether the voltage is outside an allowable range 403, initiating a stored energy and delivering a voltage to a dc/dc converter 405, generating one or more square wave(s) 407, modulating one or more square wave(s) 409, and delivering one or more modulated square wave(s) to a load 411.

Measuring the voltage from a source 401 can contain the steps of delivering the current through a comparator circuit and comparing the actual signal against a reference signal, the reference signal being the voltage at an appropriate level. The comparator can, for example, be a subtractor circuit. Comparing the actual signal against the reference signal can generate an error signal. In the event the error signal is greater than or less than a set value, a determination will be made as to whether the stored energy should be tapped.

Determining whether the voltage (actual) is outside an allowable range 403 includes the steps of comparing the error signal against a set value. The set value can be created by establishing a percentage of a nominal supply voltage. The percentage can be between ^{±}1 to 5% of the nominal supply voltage. In another embodiment, the percentage to set the value at is 1 to 10% of the nominal supply voltage.

In the event the error value is above or below the set value, which can represent a dip or surge in the voltage, the stored energy may be tapped and the energy, i.e., voltage, is delivered 405. The device to be tapped can be a capacitor. In the present invention, the power is delivered to the dc/dc converter. In one embodiment, the voltage is firstly delivered to the inverter of the converter. Following, the voltage is then passed to the high frequency transformer, for stepping up or stepping down as needed. As the transformer is of a high frequency nature, it is designed to process the high frequency switching waveform to diode circuitry. The dc/dc converter generates one or more square wave(s) 407. If the system of the present invention possesses one converter, one square wave will be generated. If the system possesses two converters, two square wave are generated, and so on.

Upon passage to a offset inverter, the generated square wave(s) is/are used to modulate a sinusoidal signal 409. In essence, the square wave is added to the sinusoidal signal, allowing the generation of a modulated wave. The modulated wave possesses the characteristics of a square wave with decreased harmonics, characteristic of a sinusoidal signal.

The modulated wave is then delivered through impedances and circuit breakers, to a load 411.

FIG. 5 shows a square wave generated by dc/dc converter of the present invention, possessing a positive portion 503, and a negative portion 501.

FIG. 6 shows another embodiment of a DVR in accordance with the present invention, such DVR containing two dc/dc converters 601/605, wherein the second dc/dc converter 605 is also connected to an energy storage 603. Both converters 601/605 are of high frequency possessing inverters, high frequency transformers passing voltage from 1-3 kHz to 10-40 kHz, and diode circuitry. The converters 601/605 provide individual square waves to the inverters 607 and 611, such inverters connected in line with the load 615. The inverters 607/611 generate the square waves to modulate sinusoidal signals. In the event of a voltage dip, the voltage dip would be detected by the system and the energy storage would be delivered to the one converter 601 and second converter 605, such converters 601 and 605 each providing a suitable DC link voltage to the inverters 607 and 611. The compensated wave generated by the inverters 607 and 611 will be delivered to the load 615. This embodiment shows the further reduction of harmonic content of the compensated waveform in comparison to utilizing one dc/dc converter.

FIG. 7 shows the multiple square waves generated from a DVR of the present invention possessing multiple dc/dc converters wherein the total number of dc/dc converter in the DVR is 5. As shown, a first dc/dc converter generates a first waveform 703, such waveform possessing a higher voltage than the second. A second dc/dc converter generates a second waveform 707, such second waveform 707 consisting of multiple smaller voltage waveforms than the first waveform 703. In such an embodiment, the various waveforms, following modulation, are combined to deliver one modulated, combined voltage to the load.

In other embodiments, n number of waveforms can be generated, as shown in FIG. 8, wherein n can be from 1 to 5, such multiple waveforms generated from adding n number of dc/dc converters to the DVR.

FIG. 9 shows the generation of a modulated sinusoidal wave 905 in accordance with the present invention, with such modulation performed by a square signal. The modulated wave 905 is created through a pure square wave 901 combined with a sinusoidal 903. The modulated wave 905 provides an appropriate voltage to the load in fast time. It can also be seen that from the modulated sinusoidal wave 905 the harmonics are reduced.

FIG. 10 is an embodiment of an apparatus of the present invention capable of generating number of square waves. As shown, each subcircuit, i.e., 101, 1003, and 1005, includes al least a static bypass, inverter, and a DC/DC converter having a high frequency AC transformer. The number of waves generated is proportioned to the # of subcircuits present. Previous FIG. 8 exhibits the generation of n square waves.

FIG. 11 shows that, through the use of dual-quasi-square wave method, additional square waves don not create significant harmonic distortion. In fact, the harmonics is very low.

### EXAMPLES

### Example 1

An H-bridge converter is used to generate the square waves for the compensation. The compensated voltage has an amplitude of 30 V and a pulse width of 5.1 ms. The test condition is based on the ac source voltage being sagged to 90Vᵣₘₛ. FIG. 12 shows, from top to bottom, the experimental compensating square wave, uncompensated sagged sinusoidal source voltage, and the compensated source voltage. It can be seen that the compensated voltage is not a pure sine wave but with lots of harmonics as expected. The rms voltage becomes 106V.

### Example 2

The dual quasi-square voltage is applied to the DVR. The aim of this part of the test is to see how the THD varies under the same compensated voltage V_{com}. FIG. 13 shown the waveform for, from top to bottom waveforms, the square wave 1; square wave 2, dipped source voltage, and the load voltage. Square wave 1 is a simple bipolar quasi-square wave with a pulse value of 30 V and 4.4-ms pulse width. Square wave 2 is to provide a small amplitude square wave to compensate for the distortion near zero crossing. It consists of two pulses in each of the positive and negative cycles each has a magnitude of 19 V and a pulse width of 1.5-ms pulse. Channel 4 shows the source voltage which is dipped to 90 Vᵣₘₛ.

The following description of certain exemplary embodiment(s) is merely exemplary in nature and is in no way intended to limit the invention, its application, or uses. Throughout this description, the term [symbol] ir conditioner? refers to a device for the cooling and often dehumidification of air in an enclosed environment.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word omprising? does not exclude the presence of other elements or acts than those listed in the given claim;

b) the word [symbol] ? or [symbol] n? preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A dynamic voltage restorer comprising,
an isolated dc/dc converter having a high frequency transformer;
an inverter;
a static bypass;
impedances; and
circuit breakers,
wherein said dynamic voltage restorer is connected to a load, and said isolated dc/dc converter is connected to an energy storage device.

2. The dynamic voltage restorer of claim 1, wherein said isolated dc/dc converter comprises diodes in an anti-parallel format, inverter, a high frequency transformer, diode circuitry, switching devices, capacitors, and transformer with primary and secondary windings.

3. The dynamic voltage restorer of claim 2, wherein said high frequency transformer passes voltage generally from 1-3 kHz to 90-100 kHz.

4. The dynamic voltage restorer of claim 2, wherein said high frequency transformer is between 0.1 to 5% of the size of a transformers that operate at 50/60 Hz.

5. The dynamic voltage restorer of claim 1, further comprising a second dc/dc converter having a high frequency transformer.

6. The dynamic voltage restorer of claim 1, further comprising n additional dc/dc converters, with each dc/dc converter having a high frequency transformer, where n=1-4.

7. A method of compensating for a voltage dip, comprising the steps of:
measuring an actual voltage;
determining whether said voltage is outside of an allowable range;
if said voltage is outside said allowable range, then following steps a-e:
a) initiating an energy storage device;
b) delivering a voltage to dc/dc converter;
c) generating a square wave from said converter;
d) modulating said square wave through a inverter; and
e) delivering a modulated square wave to a load,
otherwise
delivering a full voltage through a static bypass to a load.

8. The method of compensating for a voltage dip in claim 8, wherein determining whether said voltage is outside an allowable range occurs by comparing a generated error signal against a set value.

9. The method of compensating for a voltage dip in claim 8, wherein said allowable range is between ^{±}1 to 5% of a nominal supply voltage.

10. The method of compensating for a voltage dip in claim 8, wherein said allowable range is between ^{±}1 to 10% of a nominal supply voltage.

11. The method of compensating for a voltage dip in claim 8, wherein a voltage is delivered though a high frequency transformer to an inverter.

12. The method of compensating for a voltage dip in claim 12, wherein said voltage is between 1 to 100 kHz.

13. A method of compensating for a voltage dip, comprising the steps of:
measuring an actual voltage;
determining whether said voltage is outside of an allowable range;
if said voltage is outside said allowable range, then following steps a-e:
a) initiating an energy storage device;
b) delivering n number of voltage to n number of dc/dc converters;
c) generating a square wave from each of said converter;
d) modulating said square waves through n number of inverters; and
e) delivering a modulated, combined square wave to a load,
where n=2−5,
otherwise
delivering a current through a static bypass to a load.
